(19) United States
(12) Patent Application Publication
(10) Pub. No.: US 2008/0183657 A1
(43) Pub. Date: Jul. 31, 2008

(54) METHOD AND APPARATUS FOR PROVIDING DIRECT ACCESS TO UNIQUE HIERARCHICAL DATA ITEMS

(76) Inventors: Yuan-Chi Chang, New York, NY (US); Lipyeow Lim, North White Plains, NY (US); George Andrei Mihaila, Yorktown Heights, NY (US)

Correspondence Address: DUKE W. YEE, YEE & ASSOCIATES, P.C., P.O. BOX 802333, DALLAS, TX, 75380, US

(21) Appl. No.: 11/627,475

(22) Filed: Jan. 26, 2007

(51) Int. Cl. G06F 17/30; G06F 7/00; G06F 17/00; G06F 3/00

(52) U.S. Cl. 707/2; 707/3; 707/100; 715/713; 707/E17.061; 707/E17.087; 707/E17.001

(57) ABSTRACT

A computer implemented method, data processing system, and computer usable program code are provided for accessing unique hierarchical data. A tree structure for a document is analyzed. A determination is made as to whether a set of unique paths exist in the tree structure. Responsive to an existence of the set of unique paths, a unique path identifier is assigned to each of the set of unique paths to create a set of unique path identifiers and assigned unique path pairs. Then, the unique path identifier and a node address for the unique hierarchical data for each of the set of unique path identifiers and assigned unique path pairs is stored into a header in the document disk page.

### BACKGROUND OF THE INVENTION

1. Field of the Invention

The present invention relates generally to databases. More specifically, the present invention relates to a computer implemented method, apparatus, and computer usable program code for accessing hierarchical data items.

2. Description of the Related Art

Structured documents are documents which have nested structures. Documents written in Extensible Markup Language (XML) are structured documents. XML is quickly becoming the standard format for delivering information on the World Wide Web because this format allows a user to design a customized markup language for many classes of structured documents. XML supports user-defined tabs for better description of nested document structures and associated semantics, and encourages separation of document contents from browser presentation. XML documents have a hierarchical structure and can conceptually be interpreted as a tree structure, called an XML tree.

As more and more businesses present and exchange data in XML documents, the challenge is to store, search, and retrieve these documents using existing relational database systems. A relational database management system (RDBMS) is a database management system which uses relational techniques for storing and retrieving data. Relational databases are organized into tables, which consist of rows and columns of data. A database will typically have many tables, and each table will typically have multiple rows and columns. The tables are typically stored on direct access storage devices (DASD), such as magnetic or optical disk drives for semi-permanent storage.

Most web applications have connections to databases and use XML to transfer data from the database to the web application and vice versa. Every major database vendor has proprietary extensions for using XML with relational databases, but they take completely different approaches, and there is no interoperability between them.

Current relational database systems have evolved into hybrid systems that store both relational data and XML data. In fact, in more recent versions of International Business Machine's DB2® Database, XML was introduced as a data type. SQL/XML and XQuery are new query languages for use with the XML data type.

XQuery and SQL/XML are two standards that use declarative, portable queries to return XML by querying data. In both standards, the XML can have any desired structure, and the queries can be arbitrarily complex. XQuery is XML-centric, while SQL/XML is SQL-centric. SQL/XML is an extension of SQL that is part of ANSI/ISO SQL 2003. SQL/XML lets SQL queries create XML structures with a few powerful XML publishing functions.

Execution of queries on XML often involves retrieving specific nodes from an XML tree by navigating the XML hierarchy following a given path. However, one problem with navigation is that it incurs a significant computational overhead as addresses of multiple nodes are computed and de-referenced.

### SUMMARY OF THE INVENTION

The different illustrative embodiments provide a computer implemented method, data processing system, and computer usable program code for accessing unique hierarchical data. The illustrative embodiments analyze a tree structure for a document. The illustrative embodiments determine whether a set of unique paths exist in the tree structure. The illustrative embodiments assign a unique path identifier to each of the set of unique paths to create a set of unique path identifiers and assigned unique path pairs in response to an existence of the set of unique paths. The illustrative embodiments store the unique path identifier and a node address for the unique hierarchical data for each of the set of unique path identifiers and assigned unique path pairs into a header in the document disk page.

In another illustrative embodiment for accessing data, the illustrative embodiments receive a query request for particular data. Then, the illustrative embodiments determine whether a pointer to the particular data is found in a data structure containing pointers to a plurality of nodes in a hierarchical structure in which the plurality of nodes referenced by unique paths in responsive to receiving the query request. In this illustrative embodiment. the nodes contain data.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the exemplary embodiments may be implemented;

FIG. 2 is a block diagram of a data processing system in which the exemplary embodiments may be implemented;

FIG. 3 depicts an exemplary XML tree in accordance with an illustrative embodiment;

FIG. 4 depicts a pathtable associating unique path expressions with unique numerical path identifiers in accordance with an illustrative embodiment;

FIG. 5 depicts the layout of a header to be stored in a document disk page containing XML trees in accordance with an illustrative embodiment;

FIG. 6 depicts a flowchart for creating a header in a document for accessing unique hierarchical data items using path identifiers in accordance with an illustrative embodiment; and

FIG. 7 depicts a flowchart for the operation of accessing unique hierarchical data items using path identifiers in the header of a document in accordance with an illustrative embodiment.

### DETAILED DESCRIPTION OF THE PREFERRED EMBODIMENT

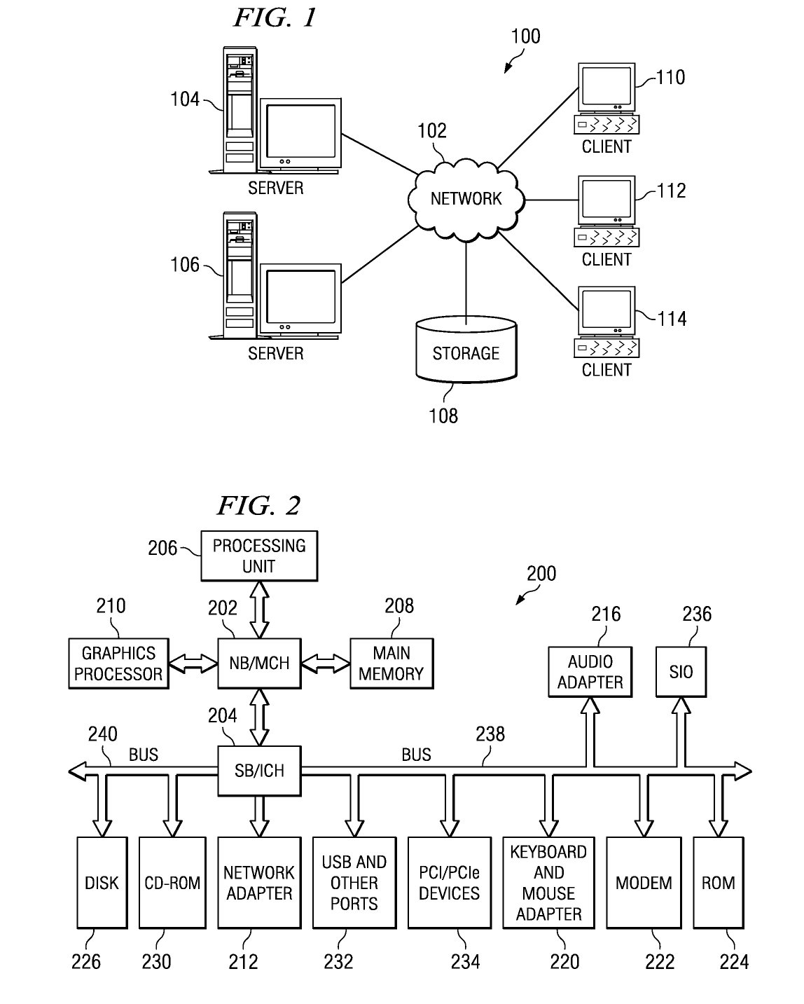

The illustrative embodiments provide for accessing unique hierarchical data items using path identifiers in the header of a document. FIGS. 1-2 are provided as exemplary diagrams of data processing environments in which embodiments may be implemented. It should be appreciated that FIGS. 1-2 are only exemplary and are not intended to assert or imply any limitation with regard to the environments in which aspects or embodiments may be implemented. Many modifications to the depicted environments may be made without departing from the spirit and scope.

With reference now to the figures, FIG. 1 depicts a pictorial representation of a network of data processing systems in which the exemplary embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which the exemplary embodiments may be implemented. Data processing system 200 is an example of a computer, such as server 104 or client 110 in FIG. 1, in which computer usable code or instructions implementing the processes for embodiments may be located.

In the depicted example, data processing system 200 employs a hub architecture including north bridge and memory controller hub (NB/MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or Linux® operating system (eServer, pSeries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 222 or network adapter 212 of FIG. 2. A memory may be, for example, main memory 208, read only memory 224, or a cache such as found in north bridge and memory controller hub 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

Hierarchical data, such as XML, is natively stored in a database as a tree. The nodes in this tree represent data items and the edges represent containment. Edges are stored as pointers inside nodes, such as child pointer array or parent pointer. Queries for specific data items in a tree often use a path pattern specification, such as XPath, that indicates the position of the data item in the tree, relative to the root of the tree. In order to retrieve the data item indicated by a path, a database engine performs the navigation steps specified by the path starting from the root. However, performing such navigation steps specified by the path starting from the root incurs a significant computation overhead, because each path specified in a query needs to be traversed, often for a large number of documents. Thus, the illustrative embodiments store inside each document disk page a header that contains an array associating each uniquely occurring path pattern with the address of the node reachable through that path. A document disk page may also be referred to as page cache or disk cache. A document disk page is a transparent cache of disk-backed pages kept in primary storage for quicker access.

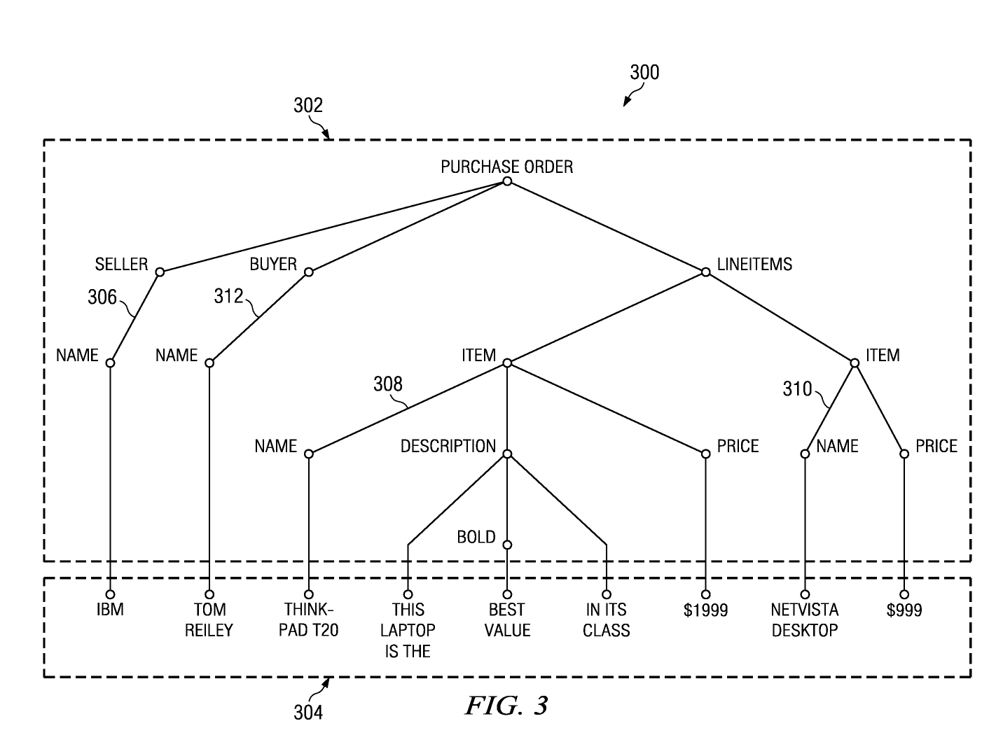

FIG. 3 depicts an exemplary XML tree in accordance with an illustrative embodiment. XML tree 300 contains internal nodes 302 that represent XML elements and leaf nodes 304 that represent data, such as text content. A typical XML query specifies one or more nodes to be retrieved from a document by means of path expressions, which may be expressed using the XPath language. For example, the path expression /PurchaseOrder/Seller/Name specifies node 306. Some path expressions uniquely specify a node, such as node 306 or node 312, while other path expressions specify a plurality of nodes. For example, the path expression /Purchaseorder/LineItems/Item/Name is matched by nodes 308 and 310 in XML tree 300. The illustrative embodiments are directed only to path expressions that uniquely specify a node in a document, such as node 306 or node 312. The information about the uniqueness of nodes specified by a path expression may be obtained from the document schema or, if a schema is not provided, directly from the document instance.

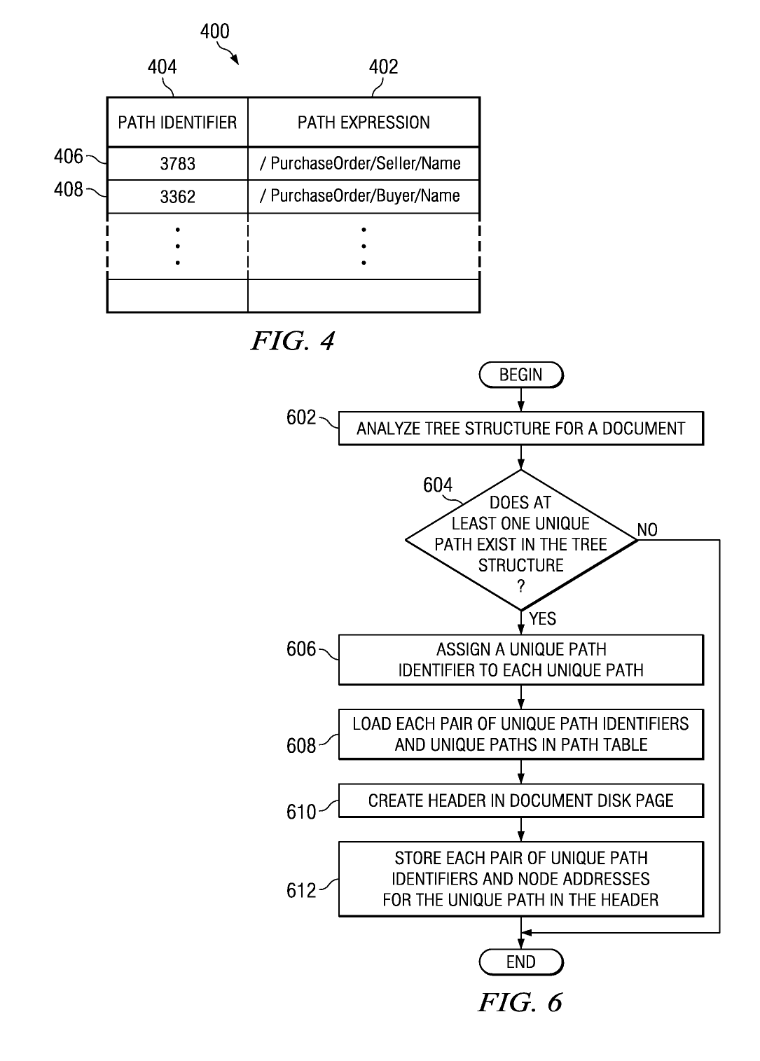

FIG. 4 depicts a path table associating unique path expressions with unique numerical path identifiers in accordance with an illustrative embodiment. Path table 400 identifies path expression 402 and path identifier 404 for a number of entries, such as entries 406 and 408. Entry 406 indicates path expression 402 as being /Purchaseorder/Seller/Name, which is the same as the path expression for node 306 in FIG. 3 and indicates path identifier 404 to be an exemplary “3783”. Entry 408 indicates path expression 402 as being /PurchaseOrder/Buyer/Name, which is the same as the path expression for node 312 in FIG. 3, and indicates path identifier 404 to be an exemplary “3362”. Path table 400 may be external to the document disk page and used by a database management system (DBMS) in order to reduce the space and time required for matching path expressions at query evaluation time.

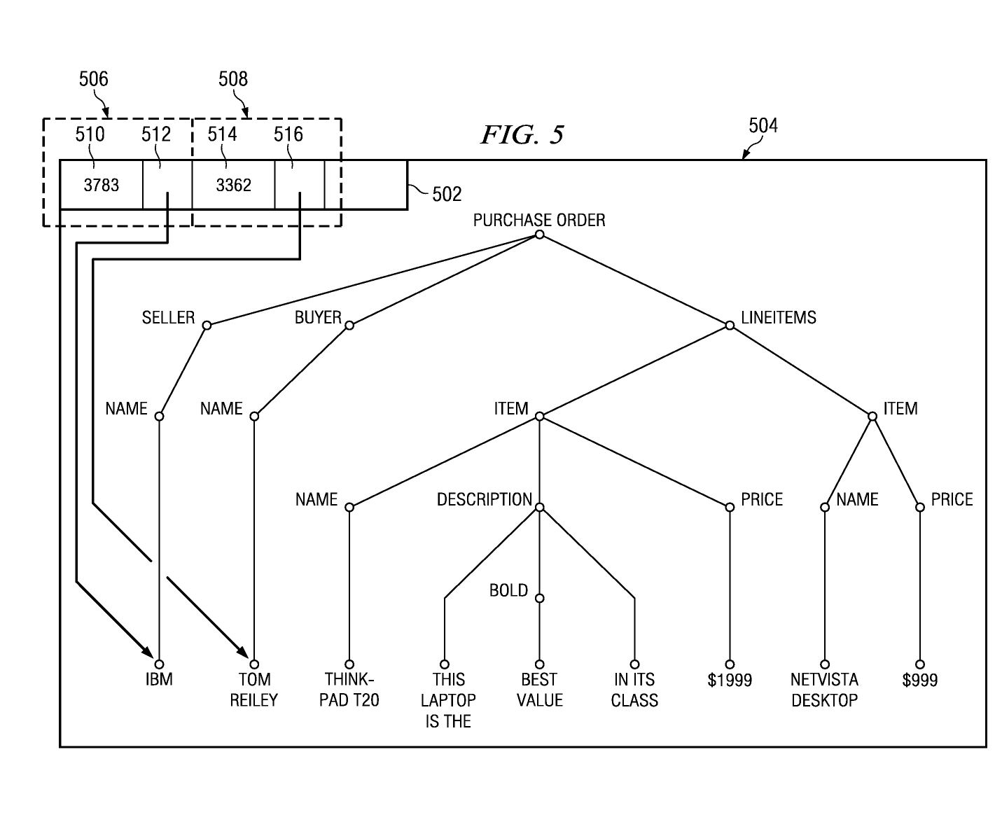

FIG. 5 depicts the layout of a header to be stored in a document disk page containing XML trees in accordance with an illustrative embodiment. In this exemplary embodiment, header 502 is stored within document disk page 504. Header 502 contains entries 506 and 508 which identify an association between uniquely occurring path identifier 510 and node address 512 and path identifier 514 and node address 516, respectively. Thus, for example, entry 506 contains path identifier 510 corresponding to the path expression /PurchaseOrder/Seller/Name, as shown in path table 400 of FIG. 4, and node address 512 contains the address of the corresponding node.

In retrieving the elements associated with the document, the processor, such as processing unit 206 of FIG. 2, analyzes document disk page 504 to determine if header 502 is present. If header 502 is present, the processor initiates a query that analyzes header 502 to identify all of the path identifiers, such as path identifiers 510 and 514 and references a path table to retrieve the path expression for each path identifier. Using the retrieved path expression and the node address, such as node address 512 and 516, the query accesses the data at the node address.

FIG. 6 depicts a flowchart for creating a header in a document for accessing unique hierarchical data items using path identifiers in accordance with an illustrative embodiment. As the operation begins, the processor analyzes a tree structure, such as XML tree 300 of FIG. 3, for a document (step 602). The processor then determines if at least one unique path exists in the tree structure (step 604). If at step 604, no unique path exists in the tree structure, then the operation ends. If at step 604, at least one unique path does exist, then the processor assigns a unique path identifier to each unique path (step 606). Then, the processor loads the unique path identifier and unique path pair into a path table, such as path table 400 of FIG. 4, (step 608). The processor then creates a header, such as header 502 of FIG. 5, in the document disk page (step 610) and stores the unique path identifier and node address for the unique path pair into the header (step 612), with the operation terminating thereafter.

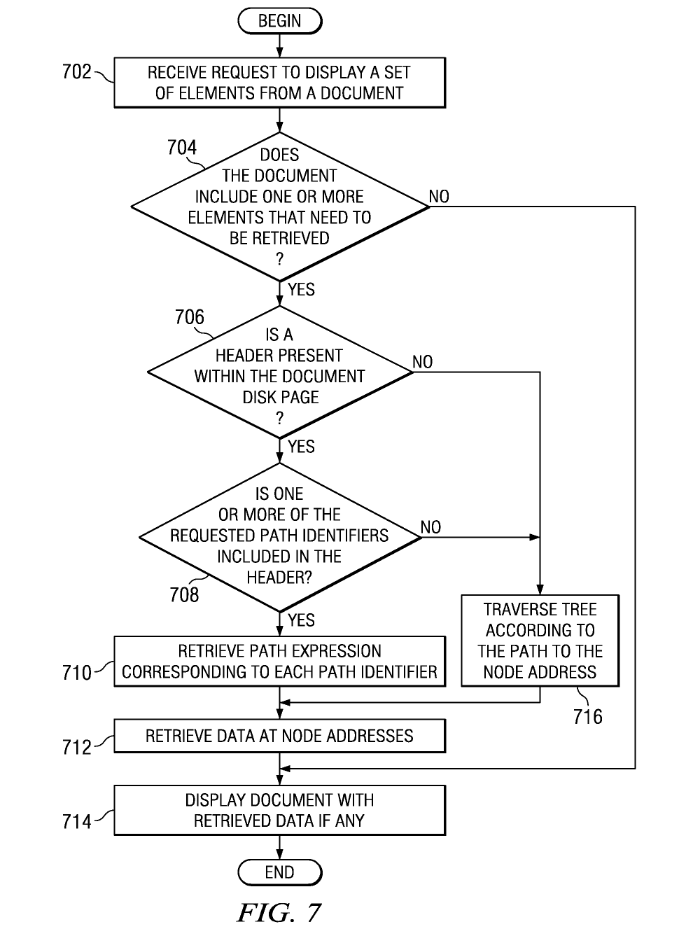

FIG. 7 depicts a flowchart for the operation of accessing unique hierarchical data items using path identifiers in the header of a document in accordance with an illustrative embodiment. As the operation begins, the processor receives a request to display a set of elements from a document, specified using path expressions (step 702). A set of elements may be one element or a plurality of elements. The processor then determines if the document includes one or more elements that need to be retrieved (step 704). If at step 704, the document does include elements that need to be retrieved, the processor initiates a query to determine if a header, such as header 502 of FIG. 5, is preset within the document disk page (step 706). If at step 706, a header is present within the document disk page, the query analyzes the document to determine if the header includes one or more of the requested path identifiers (step 708).

If at step 708, the header includes one or more path identifiers, the query retrieves the path expression corresponding to each path identifier (step 710). Using the path expression and the node address associated with the path identifier in the header, the query then retrieves the data at the node address (step 712). For the path identifiers which are not found in the header, the query traverses the tree according to the path and retrieves the data at the node address at the end of the traversal. The processor then displays the document using the retrieved data (step 714), with the operation terminating thereafter.

Returning to step 704, if the document does not include elements that need to be retrieved, the processor then displays the document using the retrieved data (step 714), with the operation terminating thereafter. Returning to step 706, if a header is not present within the document disk page, the query traverses the tree according to the tree path to the node address (step 716), with the operation proceeding to step 712 thereafter. Returning to step 708, if the header does not include any path identifiers, the query traverses the tree according to the tree path to the node address (step 716), with the operation proceeding to step 712 thereafter.

Thus, the illustrative embodiments access unique hierarchical data items using path identifiers in the header of a document. In one embodiment, a query request is received for particular data and, responsive to receiving the query request, a determination is made as to whether a pointer to the particular data is found in a data structure containing pointers to a plurality of nodes in a hierarchical structure in which the plurality of nodes are referenced by unique paths. In this embodiment, the nodes contain data. In another embodiment, a tree structure for a document is analyzed. A determination is made as to whether a set of unique paths exist in the tree structure. Responsive to an existence of the set of unique paths, a unique path identifier is assigned to the each of the set of unique paths to create a set of unique path identifiers and assigned unique path pairs. The unique path identifier and a node address for the unique hierarchical data for each of the set of unique path identifiers and assigned unique path pairs is stored into a header in the document disk page.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for accessing data, the computer implemented method comprising:
receiving a query request for particular data; and
responsive to receiving the query request, determining whether a pointer to the particular data is found in a data structure containing pointers to a plurality of nodes in a hierarchical structure in which the plurality of nodes referenced by unique paths, wherein the plurality of nodes contain the data.

2. The computer implemented method of claim 1, further comprising:
responsive to an absence of the pointer in the pointers in the data structure, traversing the hierarchical structure to identify a node containing the particular data in the hierarchical structure.

3. The computer implemented method of claim 1, wherein the data structure is a header.

4. A computer implemented method for accessing unique hierarchical data, the computer implemented method comprising:
analyzing a tree structure for a document;
determining whether a set of unique paths exist in the tree structure;
responsive to an existence of the set of unique paths, assigning a unique path identifier to each of the set of unique paths to create a set of unique path identifier and assigned unique path pairs; and
storing the unique path identifier and a node address for the unique hierarchical data for each of the set of unique path identifiers and the assigned unique path pairs into a header in a document disk page.

5. The computer implemented method of claim 4, further comprising:
receiving a request to display a set of elements from a document, specified using path expressions;
determining if the document includes the hierarchical data that needs to be retrieved;
responsive to the document including hierarchical data that needs to be retrieved, determining if the header is present in the document disk page; and
responsive to a presence of the header in the document disk page, retrieving the set of unique paths specified by each unique path identifier stored in the header.

6. The computer implemented method of claim 5, further comprising:
retrieving the unique hierarchical data associated with the set of unique paths at the node address for the unique hierarchical data.

7. The computer implemented method of claim 6, further comprising:
displaying the document with the unique hierarchical data.

8. The computer implemented method of claim 5, further comprising:
responsive to an absence of the header in the document disk page, traversing the tree structure to the node address to retrieve the unique hierarchical data.

9. The computer implemented method of claim 4, further comprising:
loading the set of unique path identifiers and the assigned unique path pairs into a path table;

10. The computer implemented method of claim 4, further comprising:
creating the header in the document disk page associated with the document.

11. The computer implemented method of claim 4, further comprising:
responsive to an absence of the set of unique paths, displaying the document with the unique hierarchical data.

12. The computer implemented method of claim 4, wherein the tree structure is an extensible markup language tree structure.

13. A data processing system comprising:
a bus system;
a communications system connected to the bus system;
a memory connected to the bus system, wherein the memory includes a set of instructions; and
a processing unit connected to the bus system, wherein the processing unit executes the set of instructions to analyze a tree structure for a document; determine whether a set of unique paths exist in the tree structure; assign a unique path identifier to each of the set of unique paths to create a set of unique path identifiers and assigned unique path pairs in response to an existence of the set of unique paths; and store the unique path identifier and a node address for unique hierarchical data for each of the set of unique path identifiers and the assigned unique path pairs into a header in a document disk page.

14. The data processing system of claim 13, wherein the processing unit executes the set of instructions to receive a request to display a set of elements from the document, specified using path expressions; determine if the document includes hierarchical data that needs to be retrieved; determine if the header is present in the document disk page in response to the document including the hierarchical data that needs to be retrieved; and retrieve the set of unique paths specified by each unique path identifier stored in the header in response to a presence of the header in the document disk page.

15. The data processing system of claim 14, wherein the processing unit executes the set of instructions to retrieve the unique hierarchical data associated with the set of unique paths at the node address for the unique hierarchical data.

16. The data processing system of claim 15, wherein the processing unit executes the set of instructions to display the document with the unique hierarchical data.

17. A computer program product comprising:
a computer usable medium including computer usable program code for accessing unique hierarchical data, the computer program product including:
computer usable program code for analyzing a tree structure for a document;
computer usable program code for determining whether a set of unique paths exist in the tree structure;
computer usable program code for assigning a unique path identifier to each of the set of unique paths to create a set of unique path identifiers and assigned unique path pairs in response to an existence of the set of unique paths; and
computer usable program code for storing the unique path identifier and a node address for the unique hierarchical data for each of the set of unique path identifiers and the assigned unique path pairs into a header in a document disk page.

18. The computer program product of claim 17, further including:
computer usable program code for receiving a request to display a set of elements from the document, specified using path expressions;
computer usable program code for determining if the document includes hierarchical data that needs to be retrieved;
computer usable program code for determining if the header is present in the document disk page in response to the document including the hierarchical data that needs to be retrieved; and
computer usable program code for retrieving the set of unique paths specified by each unique path identifier stored in the header in response to a presence of the header in the document disk page.

19. The computer program product of claim 18, further including:
computer usable program code for retrieving the unique hierarchical data associated with the set of unique paths at the node address for the unique hierarchical data.

20. The computer program product of claim 19, further including:
computer usable program code for displaying the document with the unique hierarchical data.
